(19) United States
(12) Patent Application Publication
(10) Pub. No.: US 2005/0065920 A1
(43) Pub. Date: Mar. 24, 2005

(54) System and method for similarity searching based on synonym groups

(76) Inventors: Yang He, Shenzhen (CN); Chien-Fa Yeh, Tu-Chen (TW); Chung-I Lee, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/946,307

(22) Filed: Sep. 20, 2004

(30) Foreign Application Priority Data
Sep. 19, 2003 (TW) 92125994

(51) Int. Cl. G06F 17/30

(52) U.S. Cl. 707/3

(57) ABSTRACT

A system for similarity searching based on synonym groups includes an application server (2), a number of client computers (1), and a database (3) linking to the application server through a communication means (5). The application server includes: a search request receiving module (22) for receiving search requests; a synonym group obtaining module (23) for retrieving all synonym groups containing requested terms of each search request; a search sentence generating module (24) for generating a structural query language sentence according to the retrieved synonym groups; and a search result retrieving module (25) for retrieving all kinds of data relating to the retrieved synonym groups according to the structural query language sentence. A related method for similarity searching based on synonym groups is also provided.

### BACKGROUND OF THE INVENTION

1. Field of the Invention

The present invention relates generally to systems and methods for computer-based similarity searches, and particularly to a system and method for similarity searching based on synonym groups.

2. Background of the Invention

With the increasing amount of information that is available to users via today's computer systems, efficient techniques for locating information of interest are becoming essential. To expedite the process of searching and retrieving relevant information, it is a common practice to create an index of the searchable information that is available from various information sources. For instance, if a set of documents is to be searched for information, the documents are first examined to identify terms of interest, and an index is created which associates each term with the document(s) in which it appears. Thereafter, when a user constructs a search request, the terms in that request are examined against the entries in the index, in order to locate the documents containing the requested terms.

Conventional methods of searching may not locate all of the appropriate information in the database that contains a given search term, because the corresponding term in the database is misspelled in some of the documents.

Therefore many so-called “similarity searching” methods have been recently developed in order to ameliorate this problem. For example, a technique known as “stemming” essentially involves the reduction of words to their grammatical stems. Retrieval using the stemming technique is improved, because a search which uses one form of a word locates documents containing all of the different forms of that word. Ideally, the stemming technique is applied to all words that can take different forms, and accounts for every possible form of each word. However, the rules that are used to reduce each word to its grammatical stem typically apply to only one language. Therefore, the technique can-not be employed in connection with documents containing the word in other languages. Further, the documents located are not limited to documents containing derivatives of the grammatical stem, but may also include other unwanted documents containing words which randomly match the grammatical stem.

Another example is disclosed in U.S. Pat. No. 6,618,727 issued on Sep. 9, 2003 and entitled System And Method For Performing Similarity Searching. The patent discloses a method for detecting and grading (“scoring”) similarities between documents in a source database and a search criterion. The method uses a hierarchy of parent and child categories to be searched, linking each child category with its corresponding parent category. Source database documents are converted into hierarchical database documents having parent and child objects with data values organized using the hierarchy of parent and child categories to be searched. For each child category, a child object score is calculated that is a quantitative measurement of the similarity between the hierarchical database documents and the search criterion. A parent object score is computed from its child object scores. Calculating a parent object score and its child object scores is time-consuming, and hence the search process may be unduly slow.

Accordingly, it is desired to provide a system and method that can solve the foregoing problems.

### SUMMARY OF THE INVENTION

A main objective of the present invention is to provide a system and method for similarity searching based on synonym groups which can be employed in different language sites on the World Wide Web.

Another objective of the present invention is to provide a system and method for similarity searching based on synonym groups which can perform similarity searches based on synonym groups.

To achieve the above objectives, a system for similarity searching based on synonym groups in accordance with the present invention comprises: a database for storing a host of synonym group lists and search results; a plurality of client computers for providing interactive user interfaces for users to input search requests and to view search results; and an application server. The application server comprises: a search request receiving module for receiving search requests; a synonym group obtaining module for obtaining all synonym groups containing requested terms of each search request; a search sentence generating module for generating a structural query language sentence according to the obtained synonym groups; and a search result retrieving module for retrieving all kinds of data relating to the retrieved synonym groups according to the structural query language sentence.

Further, a method for similarity searching based on synonym groups is also provided. The method comprises the steps of: receiving a search request; retrieving all synonym groups containing the requested terms of the search request; generating a structural query language sentence according to the retrieved synonym groups; and retrieving all kinds of data relating to the retrieved synonym groups based on the structural query language sentence.

Other objects, advantages and novel features of the present invention will be drawn from the following detailed description thereof with the attached drawings, in which:

### BRIEF DESCRIPTION OF THE DRAWINGS

FIG. 1 is a schematic diagram of hardware and software infrastructure of a similarity searching system according to a preferred embodiment of the present invention;

FIG. 2 is a schematic diagram of function modules of an application server of the similarity searching system of FIG. 1;

FIG. 3 is a flowchart of a preferred similarity searching method according to the present invention, utilizing the similarity searching system of FIG. 1; and

FIG. 4 is a flowchart of implementing one step of FIG. 3, namely retrieving all synonym groups containing requested terms contained in a received search request.

### DETAILED DESCRIPTION OF THE INVENTION

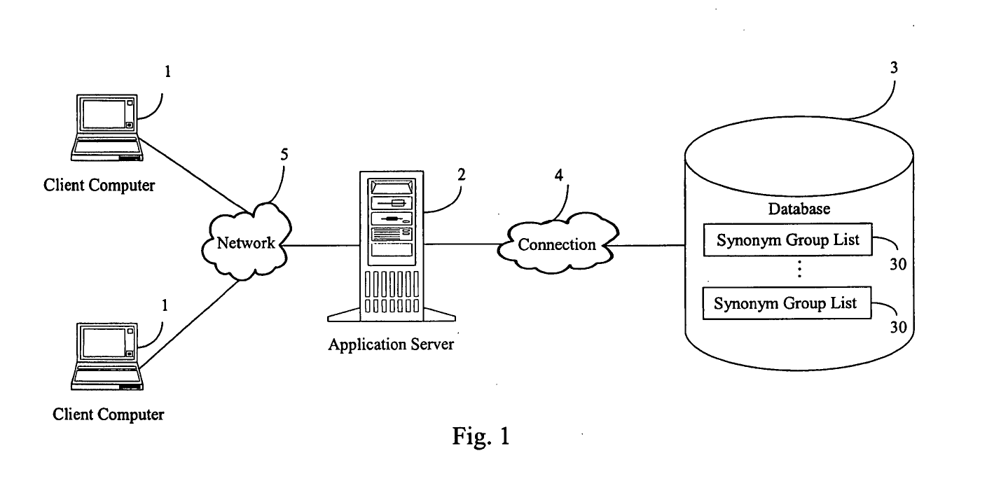

FIG. 1 is a schematic diagram of hardware and software configuration of a system for similarity searching based on synonym groups in accordance with the preferred embodiment of the present invention. A synonym is a word having the same or nearly the same meaning as another word or other words. In the preferred embodiment of the invention, a “word” represents an independent meaning, and may be a single word or a phrase containing two or more words. An original word is called an index word, which typically may have more than one synonym in any one language. The synonym may be in the same language as the index word, or may be in any other foreign language selected by a user. A synonym group is a set of synonyms that correspond to an index word. Preferably, a word may be contained in different synonym groups, which are organized into different categories. The categories for the synonym groups may be defined in any known manner; for example, by user defined classifications, according to different technical aspects, according to design or industry specifications, or according to other classification criteria. The synonym groups corresponding to a category may be separately stored in an accrued synonym group list 30. The synonym group list 30 can be comprised in a Microsoft Excel file, and can be added to as required. In particularly, the synonym group list 30 can function as a dictionary, a glossary, a thesaurus or another analysis tool, any of which can be displayed or accessed by users. Preferably, synonyms in a same language are stored in a same column of the synonym group list 30. Every two adjacent synonyms are separated by a slash “/” if an index word has more than one synonym in a same language.

The similarity searching system comprises a plurality of client computers 1, an application server 2 and a database 3. Each client computer 1 is connected with the application server 2 through a network 5. The network 5 may be any suitable communication architecture required by the similarity searching system, such as a local area network or a wide area network. Each client computer 1 is programmed to provide an interactive user interface for users of the similarity searching system to input search requests, and to view search results.

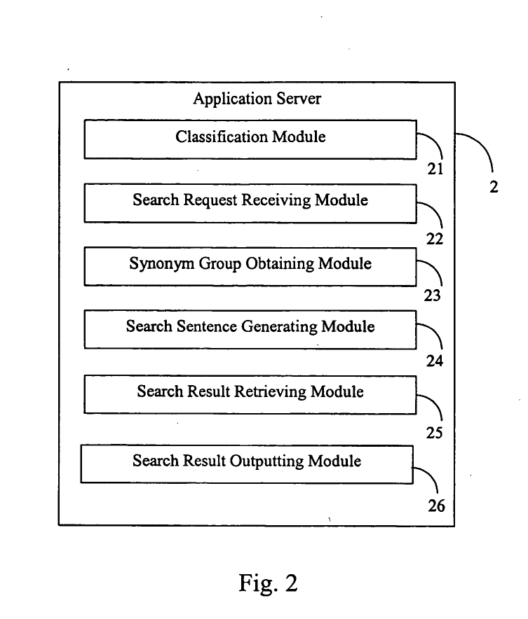

The application server 2 comprises a plurality of software function modules (described in detail below in relation to FIG. 2), and is provided to implement similarity searching and to allow users to view search results on the screen of any client computer 1. In particular, the application server 2 allows users to view one or more documents on the same display, and one or more portions or segments of different documents simultaneously so as to facilitate analysis of the search results. The application server 2 is connected with the database 3 via a connection 4, which is a database connectivity such as an ODBC (Open Database Connectivity) or a JDBC (Java Database Connectivity). The database 3 is provided for storing a host of synonym group lists 30 and search results. Each synonym group list 30 stores a host of synonym groups that correspond to a category.

FIG. 2 is a schematic diagram of function modules of the application server 2. The application server 2 comprises a classification module 21, a search request receiving module 22, a synonym group obtaining module 23, a search sentence generating module 24, a search result retrieving module 25, and a search result outputting module 26.

The classification module 21 is programmed for users to select categories. The search request receiving module 22 is for receiving search requests input by users via any of the client computers 1. The synonym group obtaining module 23 is programmed to access the synonym group lists 30, obtain requested terms from each received search request, retrieve all synonym groups containing the requested terms in the synonym group lists 30, and to display the retrieved synonym groups. The search sentence generating module 24 generates an SQL (structural query language) sentence according to the retrieved synonym groups. The search result retrieving module 25 is for retrieving all kinds of data relating to the retrieved synonym groups according to the SQL sentence. The search result outputting module 26 is for outputting the search results on the screen of any of the client computers 1.

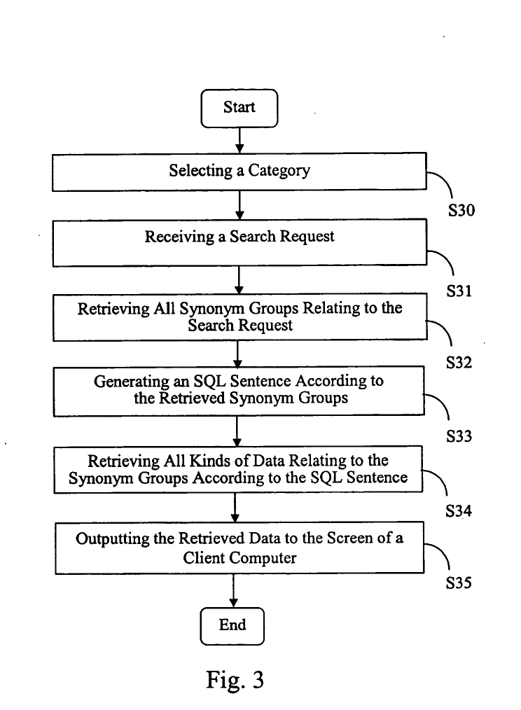

FIG. 3 is a flowchart of a preferred similarity searching method in accordance with the present invention. In step S30, a user selects a category through the classification module 21. In step S31, the search request receiving module 22 receives a search request input by the user. In step S32, the synonym group obtaining module 23 retrieves all synonym groups containing requested terms contained in the received search request. In step S33, the search sentence generating module 24 generates an SQL sentence according to the retrieved synonym groups. In the preferred embodiment of the present invention, a search request results in a single SQL sentence being generated. In step S34, the search result retrieving module 25 retrieves all kinds of data relating to the retrieved synonym groups according to the SQL sentence. In step S35, the search results outputting module 26 outputs the retrieved data relating to the retrieved synonym groups, and displays the retrieved data on the screen of a relevant client computer 1.

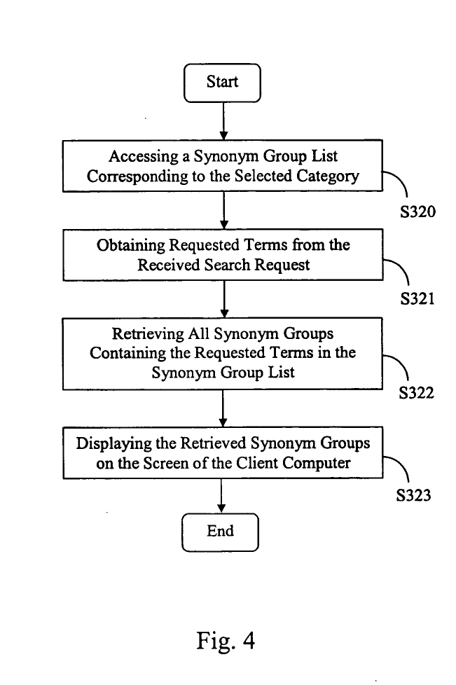

FIG. 4 is a flowchart of implementing step S32 of FIG. 3, namely retrieving all synonym groups containing requested terms contained in the received search request. In step S320, the synonym group obtaining module 23 accesses a synonym group list 30 corresponding to the selected category. In step S321, the synonym group obtaining module 23 retrieves requested terms from the received search request. In step S322, the synonym group obtaining module 23 retrieves all synonym groups containing the requested terms in the synonym group list 30. In step S323, the synonym group obtaining module 23 displays the retrieved synonym groups on the screen of the relevant client computer 1.

Although the present invention has been specifically described on the basis of a preferred embodiment and preferred methods, the invention is not to be construed as being limited thereto. Various changes or modifications may be made to said embodiment and methods without departing from the scope and spirit of the invention.

1. A system for similarity searching based on synonym groups, the system comprising an application server, a plurality of client computers and a database linking to the application server through a communication means, wherein the application server comprises:
a search request receiving module for receiving search requests;
a synonym group obtaining module for retrieving all synonym groups containing requested terms of each search request;
a search sentence generating module for generating a structural query language sentence according to the retrieved synonym groups; and
a search result retrieving module for retrieving all kinds of data relating to the retrieved synonym groups according to the structural query language sentence.

2. The system according to claim 1, wherein a synonym group is a set of synonyms corresponding to an index word, and a synonym is a word having the same or nearly the same meaning as another word or other words.

3. The system according to claim 1, wherein the synonym group obtaining module is also for accessing a synonym group list according to a selected category, obtaining requested terms from each search request, retrieving all synonym groups containing the requested terms, and displaying the retrieved synonym groups.

4. The system according to claim 3, wherein the synonym group list is comprised in a Microsoft Excel file.

5. The system according to claim 3, wherein the synonym group list is a collection of synonym groups that corresponds to a predetermined category.

6. The system according to claim 1, further comprising a classification module for users to select categories.

7. The system according to claim 1, further comprising a search result outputting module for outputting the retrieved data.

8. A method for similarity searching based on synonym groups, comprising the steps of:
receiving a search request;
retrieving all synonym groups containing requested terms of the search request;
generating a structural query language sentence according to the retrieved synonym groups; and
retrieving all kinds of data relating to the retrieved synonym groups based on the structural query language sentence.

9. The method according to claim 8, further comprising the step of selecting a category of synonym groups.

10. The method according to claim 9, wherein the step of retrieving all synonym groups containing requested terms of the search request comprises the step of accessing a synonym group list corresponding to the selected category.

11. The method according to claim 8, wherein the step of retrieving all synonym groups containing requested terms of the search request comprises the step of obtaining the requested terms from the received search request.

12. The method according to claim 8, wherein the step of retrieving all synonym groups containing requested terms of the search request comprises the step of retrieving all synonym groups containing the requested terms in the synonym group list.

13. The method according to claim 8, wherein the step of retrieving all synonym groups containing requested terms of the search request comprises the step of displaying the synonym groups.

14. The method according to claim 8, further comprising the step of outputting the retrieved data.

15. A method for similarity searching based on synonym groups, comprising the steps of:
receiving a search request;
retrieving all synonym groups containing requested terms of the search request;
generating a non-functional query language sentence according to the retrieved synonym groups; and
retrieving all kinds of data relating to the retrieved synonym groups based on the non-functional query language sentence.
